(19) United States
(12) Patent Application Publication
(10) Pub. No.: US 2024/0359896 A1
(43) Pub. Date: Oct. 31, 2024

(54) VARIABLY COMPRESSED FIBER PACKAGING AND DRY MOLDING FIBER PROCESS

(71) Applicant: Apple Inc., Cupertino, CA (US)

(72) Inventors: Mariel L. LANAS, Austin, TX (US); Manuel HODRIUS, Potsdam (DE)

(21) Appl. No.: 18/309,373

(22) Filed: Apr. 28, 2023

(51) Int. Cl. B65D 81/02; B31B 50/59

(52) U.S. Cl. CPC B65D 81/022; B31B 50/59; B65D 65/44; B31B 2110/10; B31B 2120/402; B65D 2565/382

(57) ABSTRACT

A variably-compressed dry-molded fiber packaging component includes a unitary body formed of plant-based fibers. The unitary body includes a high-compressed region and a low-compressed region. The high-compressed region has a density of at least twice that of the low-compressed region.

### FIELD

The described embodiments relate generally to fiber-based packaging material. More specifically, the present embodiments relate to variably compressed fiber-based materials for packaging formed using a dry molding process.

### BACKGROUND

The described embodiments relate generally to packaging used for packaging products. For instance, shipping packaging is used when transporting or shipping a finished goods package containing a product. And finished goods packaging is used to protect and present a contained product. It is important to provide adequate protection so that the product is not damaged in transit, while maintaining the aesthetic presentation of the product to the end user. Furthermore, the packaging material may be designed to enhance recyclability.

For consumer packaging, single-use disposable packaging containers providing protection are commonly used. Packaging containers are often produced from paperboard or carton-based packaging materials. Certain packaging may use, e.g., a polymeric film to reinforce the finished goods package. Other shipping packaging may use expanded polystyrene cushions, or other less environmentally friendly materials (e.g., plastic bubble pack materials). Environmental considerations may play a role in designing packaging. Packaging made out of recyclable and/or biodegradable materials can reduce environmental impact. However, maintaining the protective functionality of packaging while implementing such environmental materials can be a challenge.

Accordingly, there exists a need for a new and improved packaging material and/or structure that can maintain packaging integrity and cushioning characteristics during transit to an end user, while incorporating materials that allow for a high recyclability of the packaging.

### SUMMARY

Some embodiments are directed to a variably-compressed fiber packaging component. The component includes a unitary body formed of plant-based fibers. The unitary body includes a high-compressed region and a low-compressed region. The high-compressed region has a density that is at least twice the density of the low-compressed region.

Some embodiments are directed to a method for dry molding a variably-compressed fiber packaging component. The method includes positioning a dry mat of plant-based fibers between mating parts of a mold; pressing a first of the mating parts and a second of the mating parts together; compressing at least a portion of the mat between mold surfaces of the pressed-together first mating part and second mating part. When the mold surface of the first mating part is pressed together with the mold surface of the second mating part, the mold surface of the first mating part is spaced away from the mold surface of the second mating part. A distance that the first mating part mold surface is spaced away from the second mating part mold surface is different in different regions of the mold surface of the first mating part.

### BRIEF DESCRIPTION OF THE DRAWINGS

The disclosure will be readily understood by the following detailed description in conjunction with the accompanying drawings, wherein like reference numerals designate like structural elements, and in which:

FIGS. 1A-1C show sectional side views of an exemplary dry molding process using a fiber-based blank.

FIG. 2A shows a sectional side view of mating parts of a mold for forming a variably-compressed packaging component.

FIG. 2B shows an isometric view of the variably-compressed component of FIG. 2A.

FIGS. 3A-3C show sectional side views of packaging components having variable structure panels.

FIG. 4A shows a top view of a variably-compressed packaging component having a bubble pattern.

FIGS. 4B-4D show alternative sectional side views of the variably-compressed packaging component of FIG. 4A.

FIG. 5A shows a top view of a variably-compressed packaging component having an irregular pattern.

FIGS. 5B-5D show alternative sectional side views of the variably-compressed packaging component of FIG. 5A.

FIGS. 6 and 7 show top views of variably-compressed packaging components, according to some embodiments, in which FIG. 6 shows a clustering pattern and FIG. 7 shows an auxetic pattern.

FIGS. 8-10 show sectional side views of variably-compressed packaging components.

FIG. 11 shows a sectional side view of a variably-compressed component with skin material.

FIG. 12 shows a packaging assembly made of variably-compressed component packaged inside a packaging box.

FIG. 13 shows a flowchart for a method of dry molding a variably-compressed fiber packaging component.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to packaging components, particularly, variably compressed packaging components formed from a mat of low-density plant-based fiber web (e.g., cellulose fiber web) in a dry molding process. Molded-fiber products are typically made from a wet process, in which a molded fiber pulp slurry is deposited and dried on a screen mold. This results in a thin shaped fiber product having a consistent thickness and density. Fiber dry molding is a more-recently developed process, in which a mat of dry fiber is compressed into a thin shape by pressing it between parts of a mold to create a finished article, for example, a tray or container. The wall of such a finished article is typically of a consistent thickness and density, much thinner than the thickness of the fiber mat. The compression of the dry fiber mat into the thinner finished article with a uniform thickness imparts rigidity and strength to the article.

Being formed of plant-based fibers, such a finished article is readily recyclable or compostable, and can be used as an alternative to similar articles formed of less environmentally friendly materials such as plastics made of, e.g., Acrylonitrile-Butadiene-Styrene (ABS), Polyethylene (PE), Polyethylene Terephthalate (PET), Polypropylene (PP), Polystyrene (PS), etc., as sustainable solutions. However, continuing adoption requires these solutions to not only have a low environmental impact, but also to be competitive with plastics from both a performance and a cost standpoint.

Embodiments described herein leverage dry molded fiber technology used to manufacture fiber packaging by incorporating both compressed and uncompressed (or partially compressed) areas in the finished article. Such variably-compressed fiber packaging can take advantage of the rigidity and structure provided by compressed areas, while leveraging uncompressed (or less compressed) areas to provide cushioning or positional stability to a packaged product. For example, a variably-compressed fiber packaging component may form a cavity, where the cavity side walls are formed by fully-compressed fiber, while the cavity bottom wall is formed of uncompressed (or less compressed) fiber, such that the bottom wall provides cushioning to a product in the cavity, while the side walls provide rigidity and support. Such packaging including varying thickness to provide monolithic integral cushioning protection at localized positions within its wall cannot even be achieved by current manufacturing processes for plastics.

Such variably-compressed fiber packaging components can be formed by pressing an uncompressed fiber mat between two mold halves, where corresponding portions of the mold halves vary substantially in their distance from one another. For example, when pressed together, closely-spaced portions will compress the fiber mat more, creating areas of the finished fiber packaging component having high compression and rigidity, while portions spaced farther away will create areas of the finished fiber packaging component having relatively lower compression and rigidity. By compressing the fiber mat, the cellulose fibers will be bonded to each other in a way so that the resulting packaging product will have desired mechanical properties, which can be tailored and varied by controlling the degree of compression in different regions.

This unitary variable-compressed fiber packaging component has the advantages of being fully recyclable, having reduced assembly complexity (compared to using separate cushioning components), having high customizability in shape to fit and support complex product surfaces, providing the flexibility to create complex surface and pattern geometries, and more.

Such variable compression can also be applied to impart desired characteristics to the finished article. For example, different patterns or gradients of compression can create packaging components that progressively (or immediately) change in flexibility in a given direction. Such packaging components may further exhibit auxetic properties. These and other examples will be described in more detail below.

A packaging component having variable-compressed fiber structures can be used effectively for a variety of applications including not only molded containers, packaging cushioning inserts formed as or cut from sheets (e.g., similar in configuration to bubble wrap), and the like. In some embodiments, the packaging component may form a pedestal or cavity configured to hold one or more products inside packaging.

A product contained by the packaging may be, for example, an electronic device such as, for example, headphones, earphones, a laptop, tablet computer, or smartphone, or it may be a non-electronic device, such as, for example, a book. In any case, the packaging may contain additional elements housing the product (e.g., headphones within a case) and accessories for the product, such as, power adapters, cables, dongles, etc.

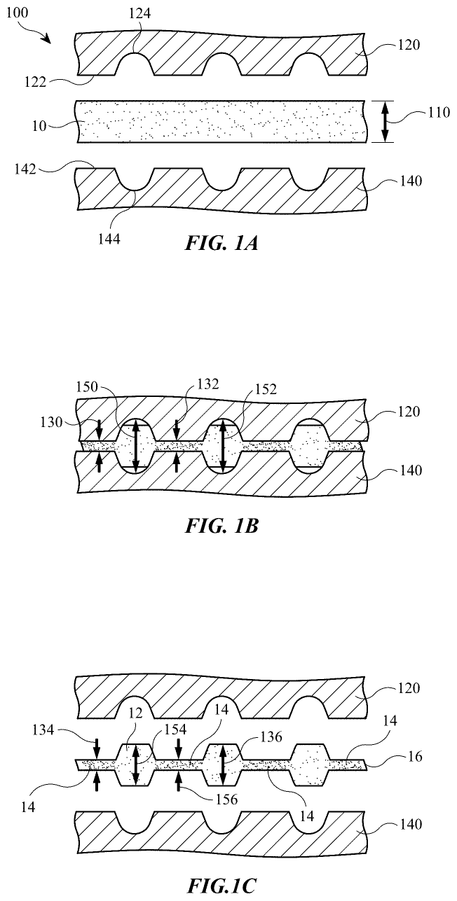

These and other embodiments are discussed below with reference to FIGS. 1-12. However, those skilled in the art will readily appreciate that the detailed description given herein with respect to these figures is for explanatory purposes only and should not be construed as limiting.

Referring to FIGS. 1A-1C, an exemplary dry molding system 100 using a fiber mat 10 is described. In particular, FIGS. 1A-1C show a sectional side view of portions of molds having facing mold surfaces, with dry fiber mat 10 positioned therebetween.

Fiber mat 10 a dry mat formed of plant-based cellulose fibers (e.g., paper or paper pulp fibers) that have been separated and then formed into an expanded web. This creates an uncompressed low-density web of cellulose fibers forming a mat having an initial thickness 110.

FIG. 1A shows a first stage in which fiber mat 10 is inserted in a mold having a mold surface shape that is a negative of that shape intended to be imparted on fiber mat 10. That is, a recess in the mold surface corresponds to a bulge to be imparted on fiber mat 10.

Fiber mat 10 may be one single integrated plant-based fiber sheet. The mold may include two (or more) mating parts 120, 140 to be mated, between which fiber mat 10 can be inserted as a preparation. As shown in FIGS. 1A-1C, upper mating part 120 has uneven surfaces 122, 124 that correspond to surfaces 142, 144, respectively, of lower mating part 140. Specifically, surface 124 is recessed upwardly relative to surface 122 in upper mating part 120, and surface 144 is recessed downwardly relative to surface 142 in lower mating part 140. Further, surface 122 is aligned with surface 142, and surface 124 is aligned with surface 144 so that recessed surfaces 124 and 144 are spaced farther apart than surfaces 122 and 142.

As shown in FIG. 1B, mating mold parts 120, 140 are moved to a compressed position, thus compressing fiber mat 10 where they contact it. As shown in FIG. 1B, portions of mat 10 positioned between the most-closely-spaced portions of mold parts 120, 140 (e.g., the portion between surfaces 122 and 142) are the most compressed, and portions of mat 10 positioned between the most-distantly-spaced portions of mold parts 120, 140 (e.g., the portion between the middle of surfaces 124 and 144) are the least compressed (possibly not compressed at all). And portions of fiber mat 10 positioned between intermediately-spaced portions of mold parts 120, 140 (e.g., the portion between the sides of surfaces 124 and 144) are compressed to a degree between the most- and least-compressed portions.

In other words, when the mold surface of mold part 120 is pressed together with the mold surface of mold part 140, the mold surface of mating part 120 is spaced away from the mold surface of mold part 140 (as shown in FIG. 1B), and a distance 150, 152 that the mold surface of mold part 120 is spaced away from the mold surface of mold part 140 is different in corresponding surfaces of different regions of the mold surfaces.

Throughout the embodiments discussed herein, stipple-shading may be shown in the corresponding figures. Such shading is generally used to visually differentiate between higher-compressed areas and lower-compressed areas, where the stippling is visibly denser in higher-compressed areas than in lower-compressed areas.

Together this can result, for example, in production of a variably-compressed packaging component 16, shown in FIG. 1C, that has low-compressed (or uncompressed) regions (e.g., regions 12 formed by the negative mold shape between concaved surfaces 124, 144) and high-compressed regions (e.g., regions 14 formed between the relatively flat surfaces 122, 142). Notably, this packaging component 16 is formed of a unitary body, with high-compressed regions and low-compressed regions integrally forming the unitary body. And the process from dry mat 10 to packaging component 16 can be completed in a dry state (e.g., without the addition of water or other liquid).

By providing varying distances (e.g., via concavities and corresponding negative shapes) on one or more mating mold parts 120, 140, it is possible to create a molded fiber packaging component having uncompressed or slightly compressed regions (e.g., low-compressed region 12), which can provide cushioning by cellulous fiber mat having fluffy characteristics. While also forming more-compressed regions (e.g., high-compressed region 14), which can provide structure and rigidity.

In some embodiments, distances between corresponding surfaces of mating parts 120, 140 may be constant or vary, regularly or irregularly. Corresponding surfaces are those that are aligned in a direction of motion of mold parts 120, 140. Referring to FIG. 1B again, distances 130, 132 between relatively flat surfaces 122, 142 may be same or different from each other. Accordingly, corresponding thicknesses 134, 156 of high-compressed regions 14 shown in FIG. 1C may be the same or different from each other. Similarly, distances 150, 152 between recessed surfaces 124, 144 may be same or different from each other, such that corresponding thicknesses 154, 156 may vary, being highly compressed, slightly compressed, or uncompressed.

In some embodiments, corresponding surfaces of mold parts 120, 140 are spaced apart (when compressed together such as in FIG. 1B) by a distance greater than the thickness of fiber mat 10, thereby creating uncompressed regions.

In some embodiments, dry molding system 100 can produce a variably-compressed fiber mat or component that has thickness that varies (in accordance with its variable compression), to be used, e.g., for packaging, where molding compression can be controlled throughout the mat to localize cushioning at particular areas of the mat. The shape and size/dimensions shown in FIGS. 1A-1C are merely one example, such that various shapes, sizes, and arrangements can be used, as described further below.

In addition, mold parts 120, 140 may be in the form of cylindrical rollers through which mat 10 can continuously roll and be compressed therebetween. Or mold parts 120, 140 may be in the form of plate molds that are pressed linearly together and apart. In either case, surfaces of the mold parts may be formed with recesses or protrusions to form corresponding low-compressed and high-compressed regions, as described above.

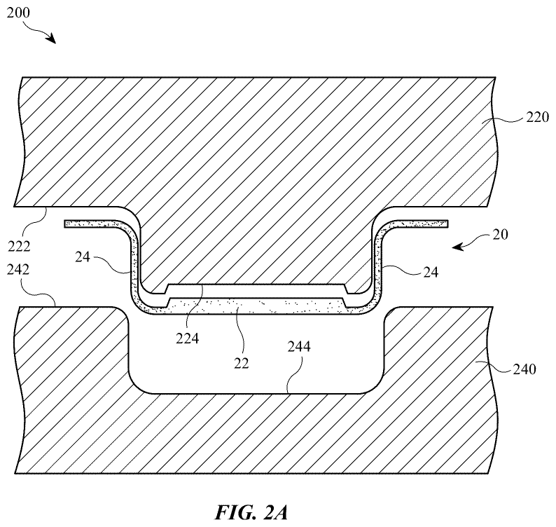

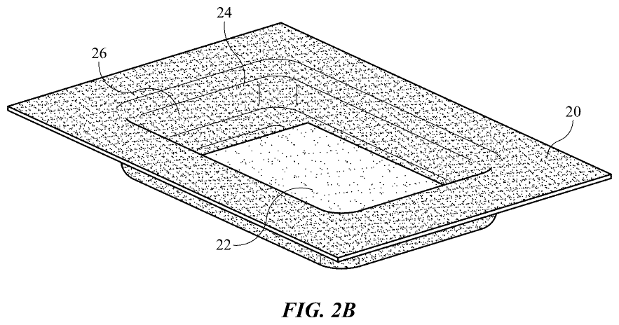

FIG. 2A illustrates a variably-compressed packaging component 20 being formed by a dry molding system 200. FIG. 2A shows packaging component 20 after being released from mold parts 220 and 240 (in a similar stage as packaging component 16 in FIG. 1C). FIG. 2B illustrates an isometric view of packaging component 20. In some embodiments, dry molding system 200 includes two mating parts: upper mold part 220 and lower mold part 240, that are pressed to each other with a plant-based fiber blank or mat therebetween (as described above for FIGS. 1A-C) to produce the final-shaped packaging component 20. In this case, packaging component 20 is formed to have a cavity 26 that can secure a consumer product therein (and optionally fit in an outer packaging box).

In some embodiments, the mold surface of one or both of upper mold part 220 and lower mold part 240 include a recesses that does not line up with a corresponding protrusion of the other mold part. For example, as shown in FIG. 2A, upper mold surface 224 includes a recess, where lower mold surface 244 is flat. This creates a greater distance between upper mold surface 224 and lower mold surface 244, which results in less compression of packaging component 20 in that area relative to its surrounding areas. This forms low-compressed region 22 (similar to low-compressed region 12 of FIG. 1C), surrounded by high-compressed region 24. In FIGS. 2A and 2B, low-compressed region 22 is formed on the bottom surface of packaging component 20 to provide cushioning protection to a bottom portion of a product, while high-compressed region 24 provides structural rigidity to packaging component 20 so that it can effectively retain its shape and maintain the position of low-compressed region 22.

For the embodiments discussed throughout this document, the difference in compression between low-compressed regions and high-compressed regions can be substantial, in order to effectively leverage the cushioning properties of the low-compressed regions and the structural properties of the high-compressed regions. For example, density of a high-compressed region may be at least 150% the density of a low-compressed region (e.g., density of a high-compressed region may be at least twice the density of a low compressed region, or at least three times or four times the density of a low compressed region). Further, thickness of high-compressed and low-compressed regions may correlate with their density, since both are driven by the degree of compression caused by (and thus the spacing apart of surfaces of) the mold parts that formed the packaging component. Thus, for example, thickness (i.e., the shortest distance through the packaging component in a given region) of a low-compressed region may be at least 150% of the thickness of a high-compressed region (e.g., thickness of a low-compressed region may be at least twice the thickness of a high compressed region, or at least three, four, or more times the thickness of a high compressed region). For example, thickness of a low compressed region may be 25-35 millimeters (e.g., 30 millimeters), while thickness of a high-compressed region may be 0.8-1.6 millimeters (e.g., 1.5 millimeters).

Such thickness and difference in thickness will also apply to the distances that corresponding regions of mating mold surfaces are spaced apart from each other (when in their fully-compressed position, such as in FIG. 1B). Also, as mentioned above, low-compressed regions may not be compressed at all, and may maintain the original thickness and density of the fiber mat from which the packaging component was formed.

Low-compressed regions can improve product protection by providing increased compressibility, resilience, and softness relative to high-compressed regions, and can be positioned to control potential abrasion areas. Controlled compressibility that can be variable, evenly or unevenly, provides cushioning in targeted areas, thus protecting a product from acceleration forces or vibrations (e.g., in a vibration or drop scenario) by acting as a buffer or shock absorber. Height or thickness difference between high-compressed and low-compressed regions can also provide protection by creating no-contact areas with the product, e.g., a flat product that mainly contacts low-compressed regions will have no or largely reduced contact with high-compressed regions, thus preventing damage (e.g., abrasion, scuffing, etc.) to portions of a product that include highly sensitive/fragile elements. Low-compressed regions may be softer and less abrasive than high-compressed regions, thus less likely to scratch or otherwise damage surfaces of a product with which they are in contact.

Dry molding system 200 not only allows the fiber mat to have variably compressed material characteristics such that the overall thickness and density vary, but also allows packaging component 20 to be molded into various shapes to accommodate and/or protect a product in which a cushioning structure can be variably formed based on the product design and protection necessity. For example, two mold parts 220, 240 can be configured to produce a differently shaped packaging component using dry molding processes as described. In addition, one mold having two mating parts can be configured to produce multiple, same or differently shaped, components at once, using one large fiber blank. Thus, any other various shape, circular, rectangular, curvedly bent shape, or even the side walls extending further out or downward can be produced by exemplary dry molding processes.

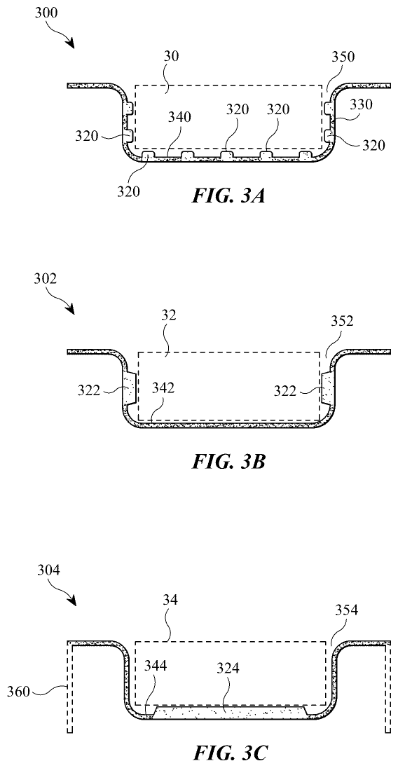

FIGS. 3A-3C show side sectional views of examples of variably-compressed dry-molded fiber packaging. Variably-compressed dry-molded fiber packaging component 300 of FIG. 3A may have a similar structure to variably-compressed component 16 of FIG. 1C with however low-compressed region 320 and high-compressed region 340 formed on one surface. That is, FIG. 3A shows a container-shaped packaging with a cavity 350 (similar to packaging component 20 of FIGS. 2A and 2B) in which a product 30 is received. Unlike currently used molded fiber packaging, which has a relatively uniform thickness throughout the entire body, packaging component 300 can have a variable thickness or height due to the difference between low-compressed regions 320 and high-compressed regions 340. In some embodiments, low-compressed regions 320 form a plurality of protrusions that are not compressed (or are less compressed than high-compressed regions) when a dry molding process is performed. FIGS. 2A and 2B on the other hand illustrate low-compressed region 22 formed of one larger protruding or bulged uncompressed region, which occupies the majority of a lower surface of packaging component 20.

A packaging component like packaging component 300 may be preferred in situations where additional structure is desired throughout the walls, while still incorporating cushioning properties. A packaging component like packaging component 20 may be preferred where maximal cushioning is desired on a bottom wall, and where rigidity on the bottom wall is not as important.

FIG. 3B shows a variably-compressed dry-molded fiber packaging component 302 holding a product 32 and having a low-compressed region 322 on side walls inside the container-shaped packaging cavity 352. Low-compressed region 322 may be one or more areas protruding from high-compressed region 342. Like the other embodiments described herein, the position and shape of low-compressed region 322 may be tailored so as to provide localized cushioning properties tailored to protect whatever product or other item is intended to be packaged with packaging component 302. For example, molded fiber packaging component 302 may be suitable for a product having a fragile or delicate portion only on the outer surfaces or in a circumstance where more side-impacts are expected, while molded fiber packaging component 300 can be targeted for a product having fragile portion(s) on the outer side and bottom surfaces. Furthermore, low-compressed region 322 may be formed on one side, two side, or all four side surfaces inside container-shaped fiber packaging component 302. In addition, a product may be more susceptible to damage when in a certain orientation, and cushioning may be added (via a low-compressed region) such that acceleration forces applied to the product in that orientation can be reduced in a particular direction, by adding a lower density area (via a low-compressed region).

FIG. 3C shows a variably-compressed dry-molded fiber packaging component 304 holding a product 34 and having a low-compressed region 324 on the bottom in a cavity 354, surrounded by high-compressed region 344, as described above for packaging component 20. In addition, packaging component 304 shows a variation of the container shape, where side walls 360 are extended out and down. Such side walls 360 may be molded in this shape, or molded initially flat (horizontal in the drawing) with and where they connect to the rest of packaging component 304 and then folded down. Side walls 360 may provide additional structural support to packaging component (e.g., when used within a base packaging box, where side walls 360 can support the bottom of the cavity of packaging component 304 above a bottom surface of the base box).

Variably-compressed dry-molded fiber packaging components shown above are examples of various packaging component and container shapes that can be formed. The cavities can also have different shapes and sizes based on product shapes. For example, a low-compressed region may have a curved surface to mate with and more effectively hold the curved surface of a product that it is intended to package. In this way, such variably-compressed dry-molded fiber packaging components can have variously formed high-compressed regions and low-compressed regions such that high customizability in shape to fit and support complex product surfaces while also providing integral localized cushioning properties is possible.

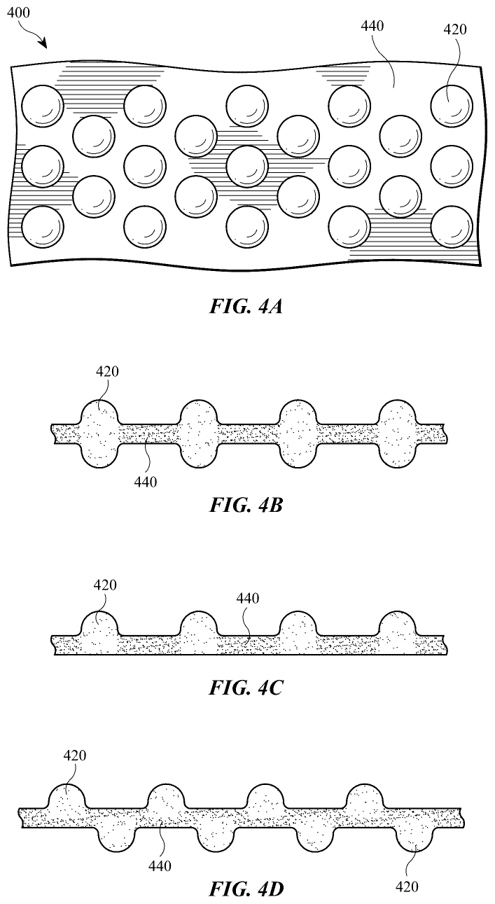

FIGS. 4A-11 show further examples of variably-compressed dry-molded fiber packaging components. For example, FIG. 4A shows a variably-compressed dry-molded fiber packaging component 400 having a “bubble wrap” cushioning structure including localized spaced-apart protrusions (in the form of “domes” in the figures). FIGS. 4B-4D show exemplary alternative sectional side views of variably-compressed dry-molded fiber packaging component 400. The variably-compressed dry-molded fiber packaging components shown and described with reference to in FIGS. 4A-7 are shown having a sheet configuration (e.g., they may be formed in large sheets of packaging material). It should be understood though that their features could also be adapted to a packaging component having a cavity, such as is shown in FIGS. 2A-3C.

As described above, the dry molding process involves compressing a low-density fiber mat between parts of a mold to create a finished packaging component. The finished article is a unitary fiber body. In the example of variably-compressed dry-molded fiber packaging component 400, it includes low-compressed regions 420 at least partially or fully surrounded by a high-compressed region 440.

In this example, low-compressed region 420 has a plurality of circular shapes (e.g., bubble or dome shapes) that are uniformly distributed in a pattern on the unitary body of variably-compressed dry-molded fiber packaging component 400. In this way, low-compressed region 420 is formed of a plurality of discrete and spaced-apart low-compressed regions 420. The shapes and sizes of low-compressed regions 420 are not limited to what is shown in FIG. 4A, such that other shapes or sizes can be formed.

Referring to FIGS. 4B-4D, low-compressed region 420 can be formed to protrude on one side or both sides of the packaging component. For example, FIG. 4B illustrates low-compressed region 420 protruding on both sides, with protrusions mirrored on opposing sides, and FIG. 4C illustrates low-compressed region 420 protruding on one side. That is, there is no transition between high-compressed region 440 and low-compressed region 420 on one side of the unitary body. In addition, FIG. 4D illustrates low-compressed region 420 arranged on upper and lower sides, with protrusions offset on opposing sides. Low-compressed region 420 can be variably compressed such that the height of each bubble may be same or different throughout the structure. In some embodiments, each bubble may be regularly or irregularly spaced apart from each other. High-compressed region 440 on the other hand has uniform thicknesses in each component of FIGS. 4B-4D.

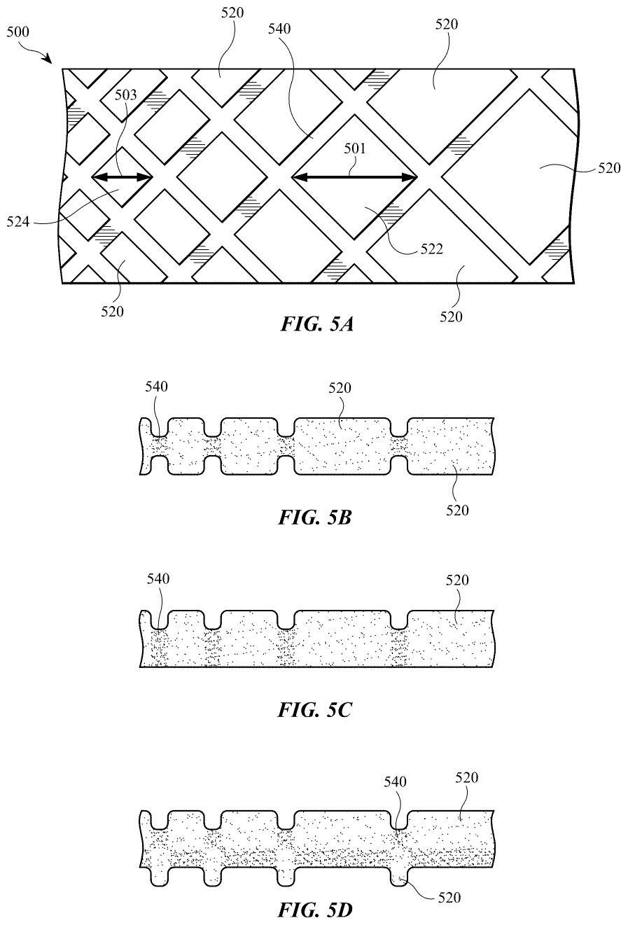

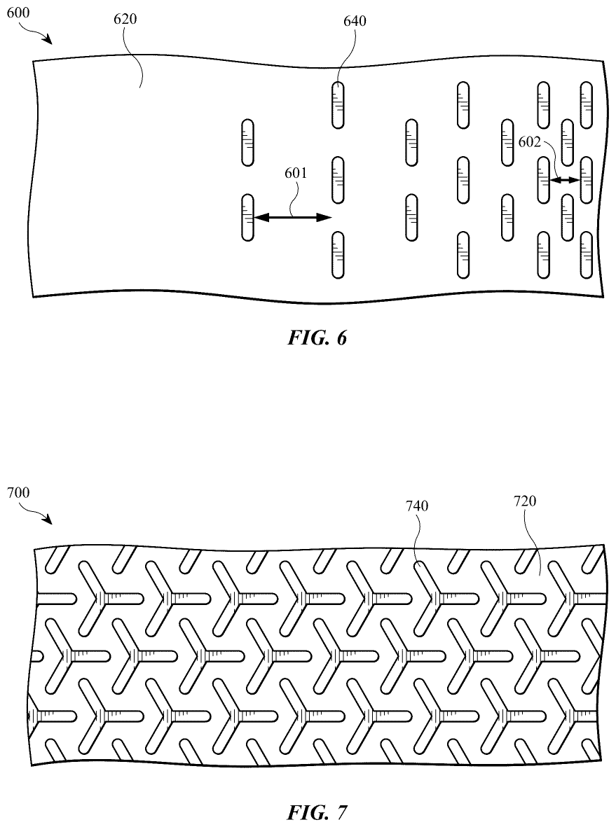

FIGS. 5A-5D show further examples of variably-compressed dry-molded fiber packaging components. For example, FIG. 5A shows a variably-compressed dry-molded fiber packaging component 500 where low-compressed regions 520 include a plurality of areas having different surface areas in a lattice pattern. For instance, one low-compressed region 522 having a diamond shape has a width 501 greater than another low-compressed region 524 in a diamond shape and having a width 503. Such widths are gradually increasing toward one direction (e.g., to the right in these figures), while the width of high-compressed region 540 remains constant. In this way, a dimension of low-compressed regions 520 varies along packaging component 500. The dimension may be correlated with size or surface area (e.g., width or area), and the variation may be one-dimensional (e.g., only increasing or only decreasing in a given direction) or multi-dimensional (e.g., variously increasing or decreasing in a given direction).

FIGS. 5B-5D show exemplary alternative sectional side views of packaging component 500. Similar to the above-described bubble shaped structure, packaging component 500 can include low-compressed regions 520 on one side (e.g., upper side) or both sides (e.g., upper and lower sides). However, unlike packaging component 400 having regularly arranged high-compressed regions, low-compressed regions 520 have a changing pattern by increasing in size (e.g., surface area) in one direction. Accordingly, high-compressed regions 540 are also more dispersedly arranged in the direction in which the size of low-compressed regions 520 increases. This configuration allows packaging component 500 to have a changing flexibility along its length. For example, the portions to the left in FIGS. 5A-5D have a greater proportion of high-compressed regions 540, and thus will be more rigid and stiff than the portions to the right, which will be less rigid and have greater cushioning properties.

Such a dynamic configuration can be leveraged to tailor rigidity and cushioning to desired areas for optimally protecting a particular product, or to provide a user with a choice in which portion of a continuous packaging component to use. For example, packaging component 500 may come in a roll or otherwise in a long sheet, and a user may cut out a portion to use (or tear, using for example, perforations through packaging component 500). The user may select the portion that has the balance of rigidity and cushioning that is most conducive to their application.

A variably-compressed dry-molded fiber packaging component 600 shown in FIG. 6 also illustrates a clustered or dispersed pattern where high-compressed regions 640 are clustered or arranged to be closer to each other in one direction (e.g., right direction). For instance, a distance 601 on high-compressed region 640 is greater than a distance 602 at the righter side. For this reason, the cushioning effect is greater toward the opposite direction (e.g., left direction). Further, contrary to packaging component 500, in packaging component 600, low-compressed region 620 completely surrounds a high-compressed region 640 having a plurality of areas thus providing further cushioning effect. While the size (e.g., surface area) of high-compressed region 640 may remain the same, the number thereof alternately varies, e.g., three, two, three . . . , as does their proximity, as shown in FIG. 6, which helps vary the stiffness of packaging component 600. However, the shapes, the total number of the areas, and/or the number of areas in each row are not limited to what is shown in FIG. 6, such that, different shapes, sizes, and numbers can be variously or alternatively used.

A variably-compressed dry-molded fiber packaging component 700 shown in FIG. 7 shows an auxetic pattern. When materials or structures with auxetic patterns such as the pattern shown are stretched they become thicker in one or several directions perpendicular to the direction of stretch or compression. Therefore, packaging component 700 having the auxetic pattern, formed by a high-compressed region 740 compressed in a certain shape to have a height (or thickness) substantially lower than a low-compressed region 720, can provide additional dynamic cushioning effects while rigidly protecting products, because high-compressed regions 740 allow for give in multiple directions when pressure is applied. To amplify these effects and allow for additional movement, in some embodiments cuts or holes may be made in high-compressed regions (e.g., high-compressed regions 740).

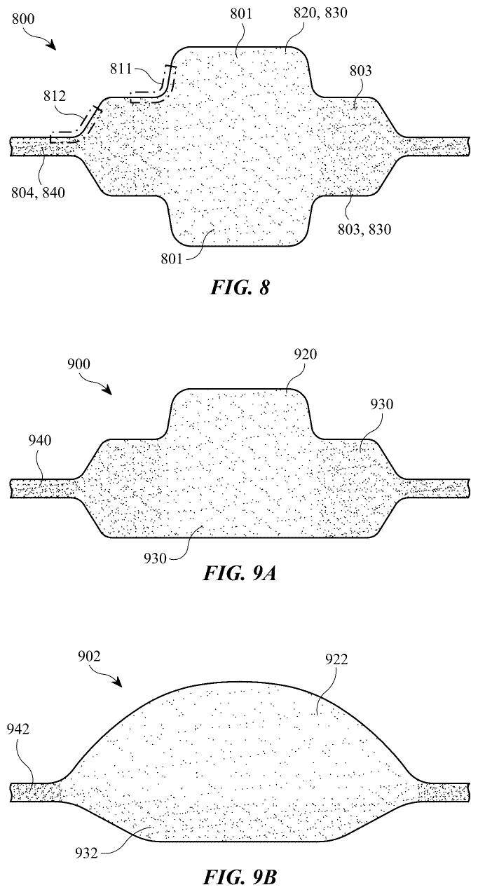

Fiber-based dry-molded packaging components can be further designed to include a mid-compressed region. Referring to FIG. 8, a variably-compressed dry-molded fiber packaging component 800 may include a low-compressed region 820 that is compressed to a lower relative degree to form a low-density region 801, a high-compressed region 840 that is compressed to a higher relative degree to form a high-density region 804, and a mid-compressed region 830 that is compressed to a degree between that of low-compressed region 820 and high-compressed region 840 to form a mid-density region 803. In the example of FIG. 8 mid-compressed region 830 forms a step between low-compressed region 820 and high-compressed region 840.

For the embodiments discussed throughout this document a mid-compressed region may have compression and thickness properties between those of a high-compressed region and a low-compressed region, and which are substantially different from both the high-compressed region and the low-compressed region. For example, a mid-compressed region may have a density that is within the middle 50% of the range of density between a high-compressed region and a low-compressed region. Or a mid-compressed region may have a thickness that is within the middle 50% of the range of thickness between a high-compressed region and a low-compressed region. Furthermore, the disclosure is not intended to limit the possible shapes that can be implemented for low-compressed, mid-compressed, and high-compressed regions, or transitions therebetween. These shapes can be suitably designed to achieve geometries corresponding to (e.g., shaped to match) surfaces of the product that they are intended to be in contact with. The shape of transitions between differently-compressed regions could be a step or slope as shown in many of the examples (e.g., transitions 811 or 812 shown in FIG. 8), but could also resemble a ramp, curve, or any other suitable spline shape.

FIG. 8 shows three differently compressed regions (820, 830, 840) formed to have different heights/densities on both upper and lower sides, in a mirrored arrangement. A variably-compressed dry-molded fiber packaging component 900 of FIG. 9A shows an arrangement that is not mirrored, with two steps in height on the top surface, and only one on the bottom, still forming a low-density region 920, a mid-density region 930, and a high-density region 940. FIG. 9B shows a variation of FIG. 9A where a variably-compressed dry-molded fiber packaging component 902 has a high-density region 924 and one low-density region 922 on one side while the opposite side has a mid-density region 932. That is, there is no transition or steps formed between low-density region and mid-density region on one side.

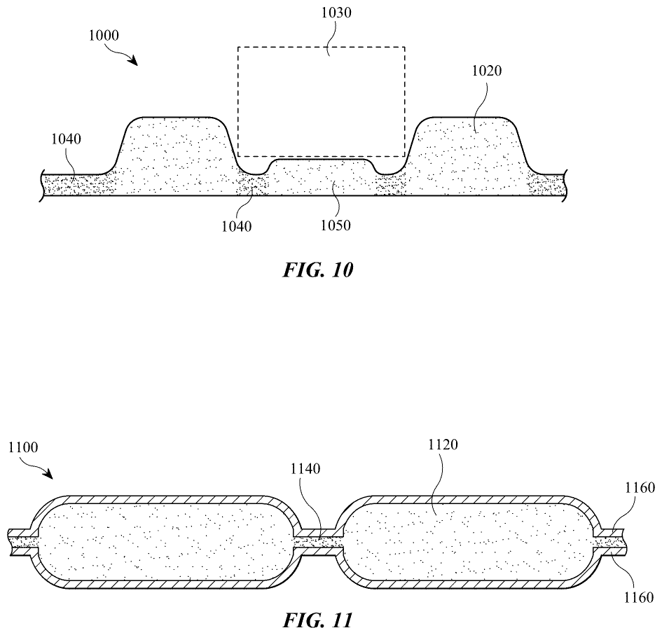

FIG. 10 illustrates another exemplary variably-compressed fiber component 1000. In some embodiments, the variably-compressed dry-molded fiber packaging component 1000 has variable heights to retain a product 1030 without further molding the variably-compressed fiber component to form, e.g., a container shape. That is, by variably compressing a fluff fiber mat to form low-compressed region 1020, mid-compressed region 1050, and high compressed region 1040, product 1030 can be secured in a retainer formed as shown.

As illustrated in FIGS. 8-10, a variably-compressed fiber component according to various embodiments has a draft angle θ to assist with releasing a final part from a mold. In some embodiments, the draft angle may be around 3º to the vertical line as shown in FIG. 10. However, it is not limited to 3º such that the angle can be greater than 3°.

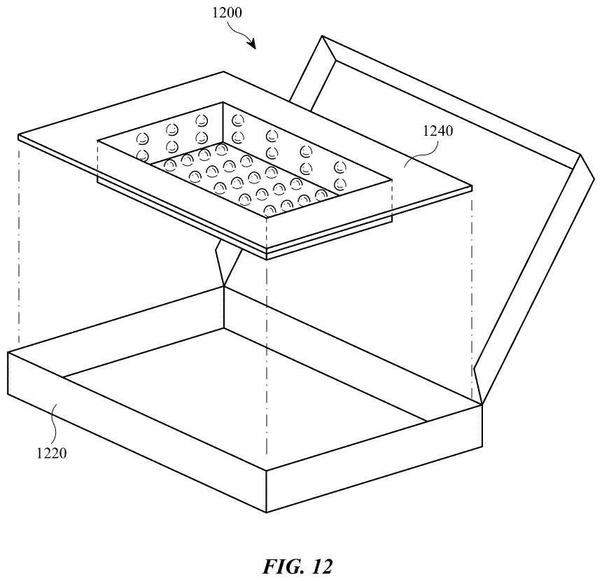

FIG. 11 shows a sectional side view of a variably-compressed dry-molded fiber packaging component 1100 having an outer skin layer 1160. Outer skin layer 1160 may be formed on one or both sides of packaging component 1100 (e.g., upper and lower sides) of variably-compressed dry-molded fiber packaging component, including any of the packaging components discussed herein. Outer skin layer 1160 is disposed over both a low-compressed region 1120 and a high-compressed region 1140 thus protecting the fiber material and adding resilience to a final packaging component. Outer skin layer may provide such protection by having a surface toughness and resistance to tearing that is greater than that of the outer surface of low-compressed regions (e.g., low-compressed region 1120). Such protection may be particularly beneficial to low-compressed regions, which may be more susceptible to fraying or other loss or material since it is not compressed as tightly together. In some embodiments, outer skin layer 1160 may itself be formed of plant-based cellulose fiber. In addition to protection, outer skin layer 1160 can be utilized to bring a desired cosmetic effect.

FIG. 12 shows an overall packaging system 1200 having an outer packaging box 1220 in which a variably-compressed dry-molded fiber packaging component 1240 is placed. Packaging component 1240 may correspond fiber packaging component 300 of FIG. 3A having a container shape with low- and high-compressed regions formed on the inner surfaces of the container. As shown, packaging component 1240 may be formed to tightly fit in outer packaging box 1220, which may have a standard size. That is, packaging component 1240 can be reconfigured to have different shapes and designs to hold a product therein while packaging box 1220 can be used for any variations of packaging component 1240.

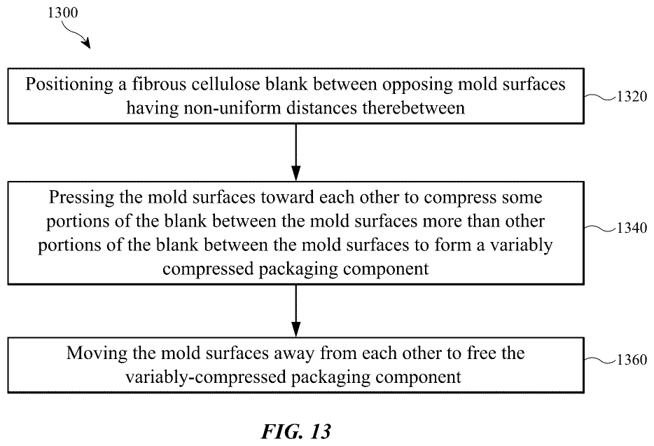

FIG. 13 shows a method 1300 of forming a variably-compressed dry-molded fiber packaging component. Method 1300 may initially include preparing a plant-based fibrous cellulose mat or blank (e.g., any fiber mat as described herein, such as fiber mat 10). This may involve a process in which cellulose fibers are firstly air-laid to form the cellulose blank. When forming the cellulose blank in the air-laid process, the cellulose fibers are carried and formed into the low-density fluffy blank structure by air as carrying medium.

Method 1300 may further include positioning the mat between mating parts of a mold (e.g., any mold or mold parts described herein, such as mold parts 120, 140) having non-uniform distances between opposing mold surfaces at step 1320, and pressing a first of the mating parts and a second of the mating parts together at step 1340. That is, the mold surfaces may be pressed toward each other to compress some portions of the mat or blank between the mold surfaces more than other portions of the mat between the mold surfaces to form a variably-compressed packaging component. The mold surfaces then may move away from each other to free the variably-compressed packaging component (e.g., variably-compressed packaging component 16) at step 1360.

Fibers or fibrous structures used for the unitary body (e.g., the fiber blank or mat) may be naturally occurring fibers or plant-based fibers that can be found in nature in a suitable form. An example of a naturally occurring fiber is a wood pulp fiber (e.g., cotton, flax, hemp, bamboo, sisal, jute, etc.). In addition, the term “fiber” means an elongate particulate having an apparent length greatly exceeding its apparent width. More specifically, and as used herein, fiber refers to plant-based cellulose fibers (e.g., those suitable for a papermaking process).

Each of the components and their constituent parts, and other variations described herein may include corresponding features described with reference to each of the other components and features described without limitation.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A variably-compressed fiber packaging component, comprising:
a unitary body formed of plant-based fibers, wherein the unitary body comprises:
a high-compressed region; and
a low-compressed region,
wherein the high-compressed region has a density that is at least twice that of the low-compressed region.

2. The variably-compressed fiber packaging component of claim 1, wherein the low-compressed region has a thickness at least twice that of the high-compressed region.

3. The variably-compressed fiber packaging component of claim 1, wherein the high-compressed region surrounds the low-compressed region.

4. The variably-compressed fiber packaging component of claim 1, wherein the high-compressed region has a total surface area greater than that of the low-compressed region.

5. The variably-compressed fiber packaging component of claim 1, wherein there is no transition between the high-compressed region and the low-compressed region on one side of the unitary body.

6. The variably-compressed fiber packaging component of claim 1, further comprising a mid-compressed region,
wherein the mid-compressed region has a density that is greater than the density of the low-compressed region and lower the density of the high-compressed region.

7. The variably-compressed fiber packaging component of claim 1, wherein the low-compressed region is formed of a plurality of discrete low-compressed regions, and wherein the high-compressed region is formed of a single continuous high-compressed region.

8. The variably-compressed fiber packaging component of claim 7, wherein the low-compressed regions are uniformly distributed within at least an area of the unitary body.

9. The variably-compressed fiber packaging component of claim 7, wherein the low-compressed regions vary in at least one of size and spacing in at least one direction of the unitary body.

10. The variably-compressed fiber packaging component of claim 1, wherein the low-compressed region is an uncompressed region.

11. The variably-compressed fiber packaging component of claim 1, further comprising a skin layer entirely covering both sides of the unitary body, the skin layer having a greater resistance to tearing than an outer surface of the low-compressed region.

12. The variably-compressed fiber packaging component of claim 1, wherein the unitary body defines a cavity configured to receive a product.

13. The variably-compressed fiber packaging component of claim 12, wherein the cavity is defined by side walls and a bottom wall, and
wherein the low-compressed region is disposed in a portion of the cavity configured to be in contact with the product.

14. The variably-compressed fiber packaging component of claim 1, further comprising a transition region disposed between the high-compressed region and the low-compressed region, wherein the transition region has a curved shape.

15. A method for dry molding a variably-compressed fiber packaging component, the method comprising:
positioning a dry mat of plant-based fibers between mating parts of a mold;
pressing a first of the mating parts and a second of the mating parts together;
compressing at least a portion of the mat between mold surfaces of the pressed-together first mating part and second mating part,
wherein, when the mold surface of the first mating part is pressed together with the mold surface of the second mating part, the mold surface of the first mating part is spaced away from the mold surface of the second mating part, and
wherein a distance that the first mating part mold surface is spaced away from the second mating part mold surface is different in different regions of the mold surface of the first mating part.

16. The method of claim 15, wherein, when the first mating part and the second mating part are pressed together, the distance that a first region of the first mating part mold surface is spaced apart from the second mating part mold surface is at least twice the distance that a second region of the first mating part mold surface is spaced apart from the second mating part mold surface.

17. The method of claim 15, wherein the mold surface of the first mating part has a recess, and
wherein the mold surface of the second mating part does not have a protrusion in in a position aligned with the recess.

18. The method of claim 15, wherein the compressing forms a unitary body of a fiber packaging component having low-compressed region and a high-compressed region,
wherein the low-compressed region is at least twice as thick as the high-compressed region.

19. The method of claim 18, further comprising applying a skin layer over at least one surface of the unitary body.

20. The method of claim 18, further comprising applying a skin layer over the low-compressed region, wherein the skin layer has a greater resistance to tearing than a surface of the low-compressed region.
